(19) United States
(12) Patent Application Publication
(10) Pub. No.: US 2013/0322085 A1
(43) Pub. Date: Dec. 5, 2013

(54) HEAT DISSIPATION MODULE FOR LED LAMP

(71) Applicants: CHIN-SHENG WEN, NEW TAIPEI CITY (TW); YUNG-KUN CHEN, TAIPEI CITY (TW)

(72) Inventors: CHIN-SHENG WEN, NEW TAIPEI CITY (TW); YUNG-KUN CHEN, TAIPEI CITY (TW)

(21) Appl. No.: 13/666,154

(22) Filed: Nov. 1, 2012

(30) Foreign Application Priority Data
Jun. 1, 2012 (TW) 101210566

(51) Int. Cl. F21V 29/00

(52) U.S. Cl. 362/294; 362/382

(57) ABSTRACT

A heat dissipation module for LED lamp includes a heat-sink base, radiation fins radially mounted around said heat-sink base, each radiation fin having a first mounting device at a top end thereof and a second mounting device at a bottom end thereof, a first locating frame attached to the top ends of the radiation fins and fastened to the first mounting devices of the radiation fins by respective first rivets, and a second locating frame attached to the bottom ends of the radiation fins and fastened to the second mounting devices of the radiation fins by respective second rivets.

### BACKGROUND OF THE INVENTION

1. Field of the Invention

The present invention relates to LED lamp technology and more particularly, to a heat dissipation module for use with a LED light-emitting module to constitute a LED lamp.

2. Description of the Related Art

Commercial LED bulbs use light-emitting diodes to give off light for illumination. For the advantages of power saving, long service life and non-toxicity, LED bulb has become the mainstream of the lighting fixture industry. However, a LED bulb generates much waste heat during operation. Accumulation of waste heat in a LED bulb will affect the performance of the LED bulb and shorten its lifespan. Heat sinks for LED bulb application are developed. A known heat sink comprises a heat-sink base for supporting light-emitting devices, and a plurality of radiation fins radially mounted around the heat-sink base. During operation of the light-emitting devices, heat energy is transferred by the heat-sink base from the light-emitting devices to the radiation fins and then dissipated into the outside open air by the radiation fins.

Conventionally, radiation fins for the aforesaid purpose are made of aluminum alloy sheet materials using a stamping technique, having hook strips and hook holes at two opposite sides. During installation, radiation fins are radially mounted around the heat-sink base at predetermined intervals, and linked together by fastening the hook strips of one radiation fin to the hook holes of another. A locating ring may be attached to one end of the radiation fins around the heat-sink base to hold down the radiation fins. However, radiation fins that are fastened together using a press-fit or snap-fit fastening technique come loose easily. The poor assembly quality of this design of LED bulb is not suitable for outdoor applications. It can easily be damaged under thread of severe weather.

Therefore, it is desirable to provide a heat dissipation module for LED lamp that eliminates the instability mounting drawbacks of the prior art designs.

### SUMMARY OF THE INVENTION

The present invention has been accomplished under the circumstances in view. It is the main object of the present invention to provide a heat dissipation module for LED lamp, which has the characteristics of simple structural design, high structural stability, weather resistance, and long lifespan.

To achieve this and other objects of the present invention, a heat dissipation module for LED lamp comprises a heat-sink base, a plurality of radiation fins, a first locating frame, and a second locating frame. The heat-sink base comprises a plurality of longitudinal mounting grooves spaced around an outer perimeter thereof at predetermined intervals.

The radiation fins are radially mounted around the heat-sink base, each comprising an inner edge fastened to one longitudinal mounting groove of the heat-sink base, an outer edge opposite to the inner edge, a top end, a bottom end opposite to the top end, a first mounting device located at the top end, and a second mounting device located at the bottom end. The first locating frame is attached to the top ends of the radiation fins around the heat-sink base, and fastened to the first mounting devices at the top ends of the radiation fins by respective first rivets. The second locating frame is attached to the bottom ends of the radiation fins around the heat-sink base, and fastened to the second mounting devices at the bottom end of the radiation fins by respective second rivets.

Further, the first mounting device of each radiation fin comprises a first lug protruded from the top end of the respective radiation fin, and a rivet hole cut through the first lug and fastened to the first locating frame by one first rivet. Further, the second mounting device of each radiation fin comprises a second lug protruded from the bottom end of the respective radiation fin, and a rivet hole cut through the second lug and fastened to the second locating frame by one second rivet.

Further, each radiation fin comprises a first step first step located at the top end and abutted to the outer edge to support the first locating frame. Further, the first lug of the first mounting device is located at the first step for the mounting of the first locating frame.

Further, each radiation fin further comprises a second step located at the bottom end and abutted to the inner edge to support the second locating frame. Further, the second lug of the second mounting device is located at the second step for the mounting of the second locating frame.

Further, the heat-sink base is shaped like a metal tube. Further, the radiation fins are radially arranged around the heat-sink base in circle. Further, the first locating frame and the second locating frame are ring shaped.

Further, each radiation fin comprises a third step located at the top end and abutted against the inner edge, and a horizontal supporting flange located at the third step. The horizontal supporting flanges of the third steps of the radiation fins are arranged on one same elevation and defining an accommodation chamber A.

The heat dissipation module further comprises a heat transfer plate bonded to the horizontal supporting flanges of the radiation fins to support a LED light-emitting module, an inner ring mounted around the heat transfer plate, a lens mounted in the inner ring over the LED light-emitting module at the heat transfer plate, and an outer ring fastened to the inner ring to hold down the lens in the inner ring.

Subject to the mounting design of the heat-sink base, the radiation fins, the first locating frame and the second locating frame, the first locating frame can be riveted to the first mounting devices at the top ends of the radiation fins, and the second locating frame can be riveted to the second mounting devices at the bottom ends of the radiation fins. Thus, the heat dissipation module can be easily and stably assembled together to support a LED light-emitting module at the top ends of the radiation fins, forming a LED lamp for outdoor applications. A LED lamp made according to the present invention is durable against weather, suitable for streetlight or searchlight application.

### BRIEF DESCRIPTION OF THE DRAWINGS

FIG. 1 is an oblique top elevational view of a heat dissipation module for LED lamp in accordance with the present invention.

FIG. 2 is an oblique bottom elevational view of the heat dissipation module for LED lamp in accordance with the present invention.

FIG. 3 is an exploded view of a part of the heat dissipation module for LED lamp in accordance with the present invention.

FIG. 4 is an oblique top exploded view of the heat dissipation module for LED lamp in accordance with the present invention.

FIG. 5 is an oblique bottom exploded view of the heat dissipation module for LED lamp in accordance with the present invention.

FIG. 6 is a sectional side plain view of the heat dissipation module for LED lamp in accordance with the present invention.

### DETAILED DESCRIPTION OF THE PREFERRED EMBODIMENT

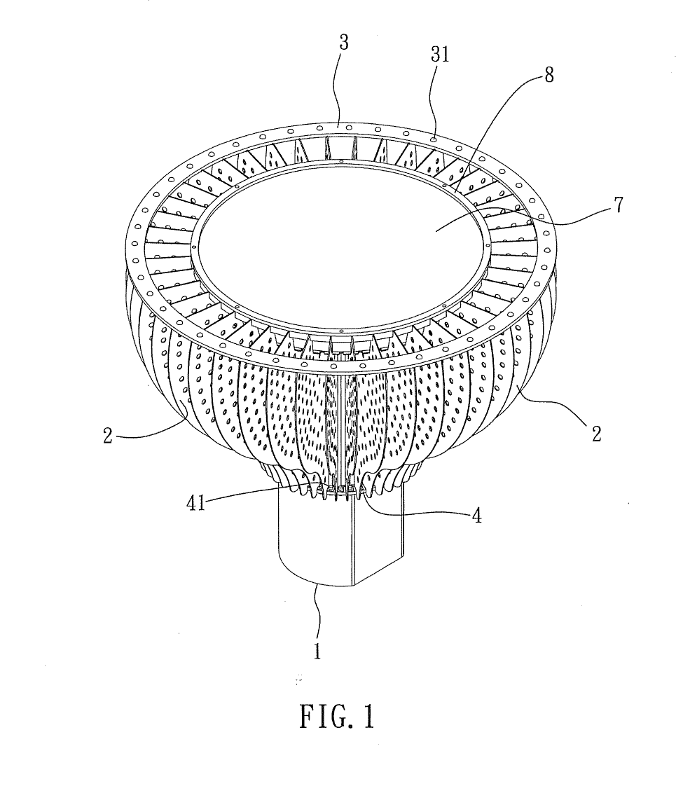

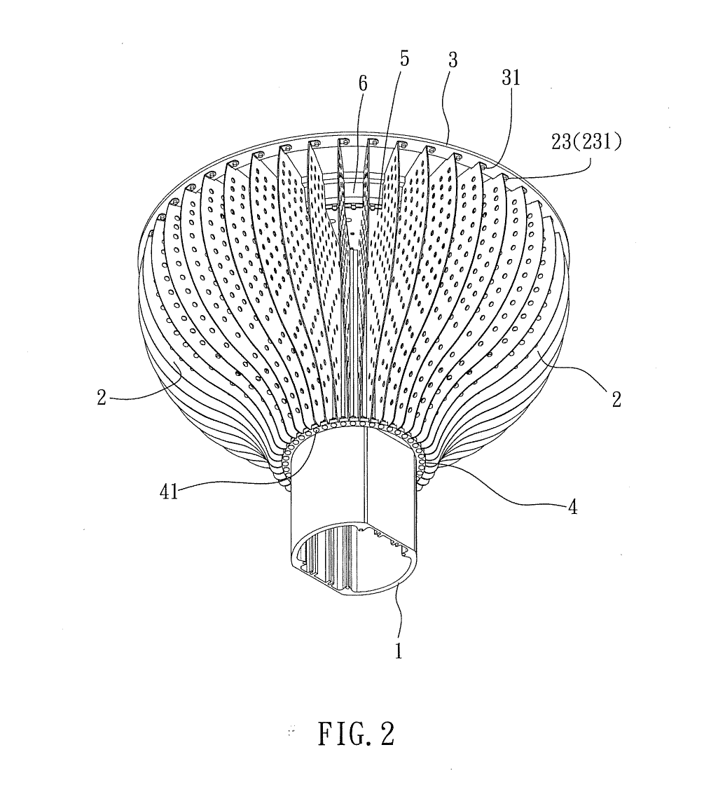

Referring to FIGS. 1 and 2, a heat dissipation module in accordance with the present invention is shown to be assembled with a LED light-emitting module into a LED lamp. The heat dissipation module comprises a heat-sink base 1, a plurality of radiation fins 2 radially mounted around the heat-sink base 1, a first locating frame 3 fastened to the radiation fins 2 at a top side, and a second locating frame 4 fastened to the radiation fins 2 at a bottom side. The first locating frames 3 and the second locating frames 4 are ring shaped.

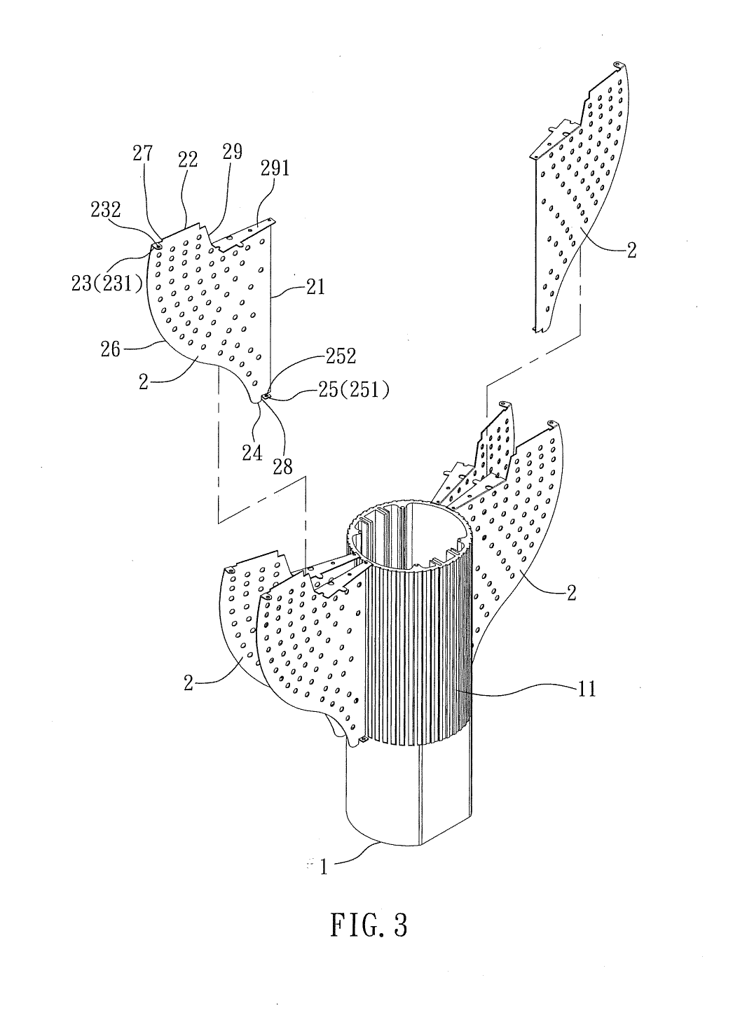

Referring to FIG. 3, the heat-sink base 1 is a tubular metal member comprising a plurality of longitudinal mounting grooves 11 spaced around the outer perimeter thereof at predetermined intervals for the mounting of the radiation fins 2 respectively. Each radiation fin 2 comprises opposing inner edge 21 and outer edge 26, and opposing top end 22 and bottom end 24. By means of press-fitting the inner edges 21 of the radiation fins 2 into the respective longitudinal mounting grooves 11 of the heat-sink base 1, the radiation fins 2 are secured to the outer perimeter of the heat-sink base 1 in a radial manner. Each radiation fin 2 further comprises a first mounting device 23 located at the top end 22 thereof and fastened to the first locating frame 3, and a second mounting device 25 located at the bottom end 24 and fastened to the second locating frame 4.

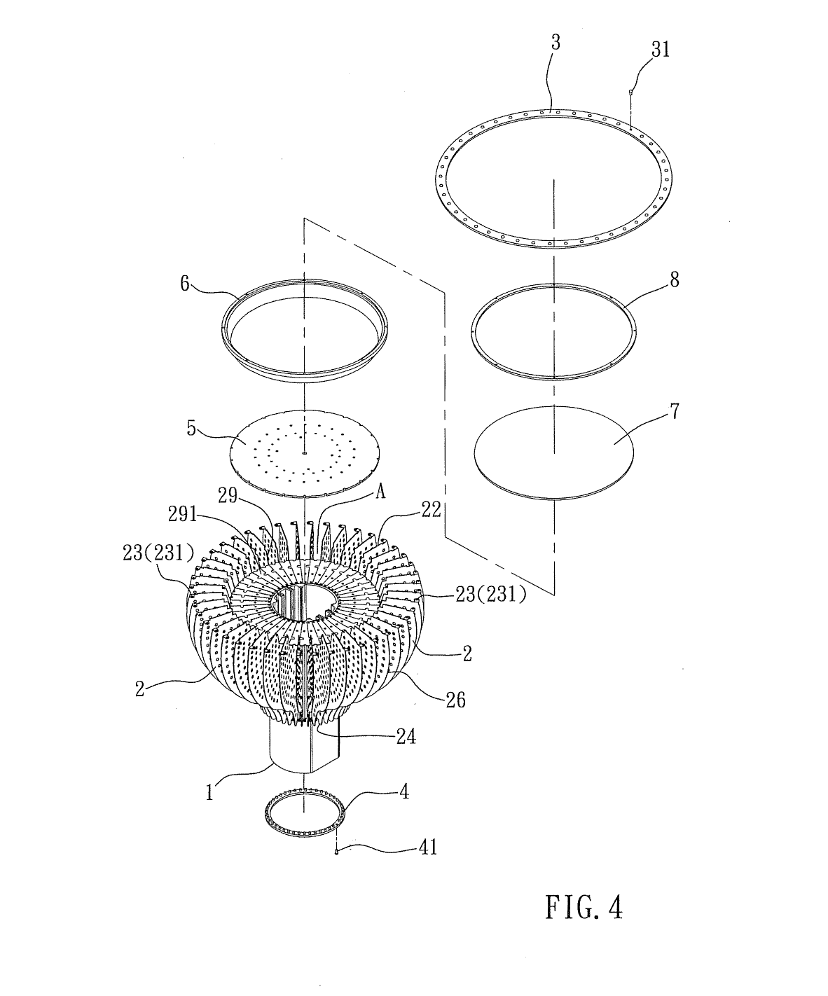

Referring to FIG. 4, the first locating frame 3 is attached to the top ends 22 of the radiation fins 2 around the heat-sink base 1 and fastened to the first mounting devices 23 at the top ends 22 of the radiation fins 2 by respective first rivets 31.

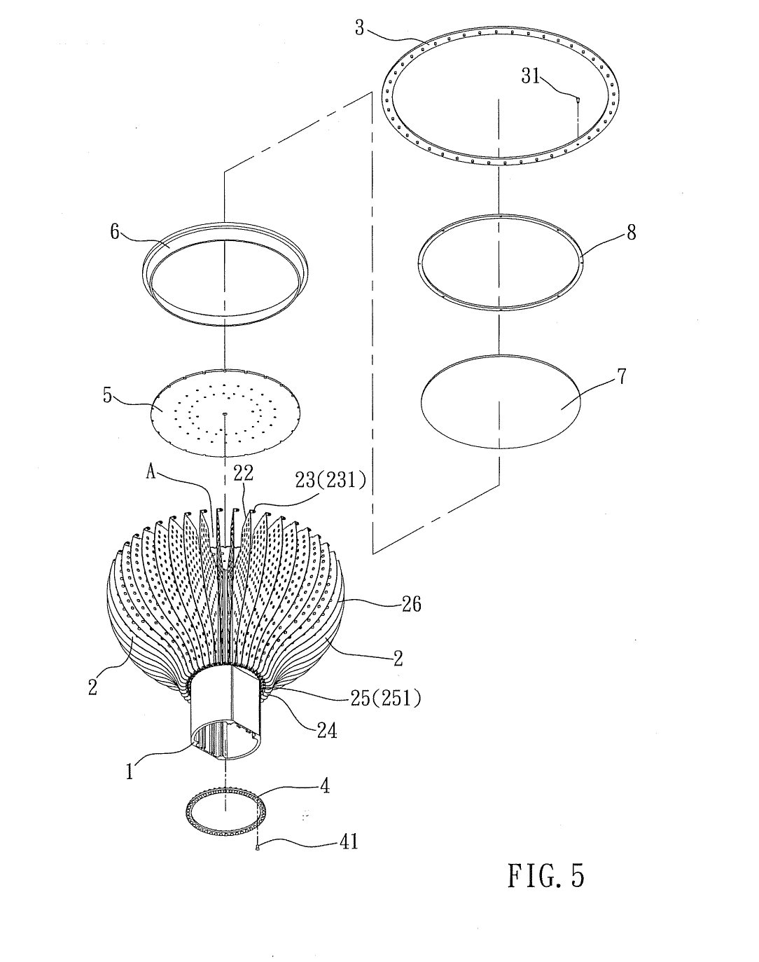

Referring to FIG. 5, the second locating frame 4 is attached to the bottom ends 24 of the radiation fins 2 around the heat-sink base 1 and fastened to the second mounting devices 25 at the bottom end 24 of the radiation fins 2 by respective second rivets 41. Thus, the heat-sink base 1, the radiation fins 2, the first locating frame 3 and the second locating frame 4 are firmly secured together.

Subject to the mounting design of the heat-sink base 1, the radiation fins 2, the first locating frame 3 and the second locating frame 4, the first locating frame 3 can be riveted to the first mounting devices 23 at the top ends 22 of the radiation fins 2, and the second locating frame 4 can be riveted to the second mounting devices 25 at the bottom ends 24 of the radiation fins 2. Thus, the heat dissipation module can be easily and stably assembled together to support a LED light-emitting module (not shown) at the top ends 22 of the radiation fins 2, forming a LED lamp for outdoor applications. A LED lamp made according to the present invention is durable against weather, suitable for streetlight or searchlight application.

Referring to FIGS. 3 and 4 again, the first mounting device 23 of each radiation fin 2 comprises a first lug 231 protruded from the top end 22 of the respective radiation fin 2, and a rivet hole 232 cut through the first lug 231. After insertion of the inner edges 21 of the radiation fins 2 into the respective longitudinal mounting grooves 11 of the heat-sink base 1, the first lugs 231 of the first mounting devices 23 of the radiation fins 2 are kept on one same plane for the mounting of the first locating frame 3.

Referring to FIGS. 3 and 5 again, the second mounting device 25 of each radiation fin 2 comprises a second lug 251 protruded from the bottom end 24 of the respective radiation fin 2, and a rivet hole 252 cut through the second lug 251. After insertion of the inner edges 21 of the radiation fins 2 into the respective longitudinal mounting grooves 11 of the heat-sink base 1, the second lugs 251 of the second mounting devices 25 of the radiation fins 2 are kept on one same plane for the mounting of the second locating frame 4.

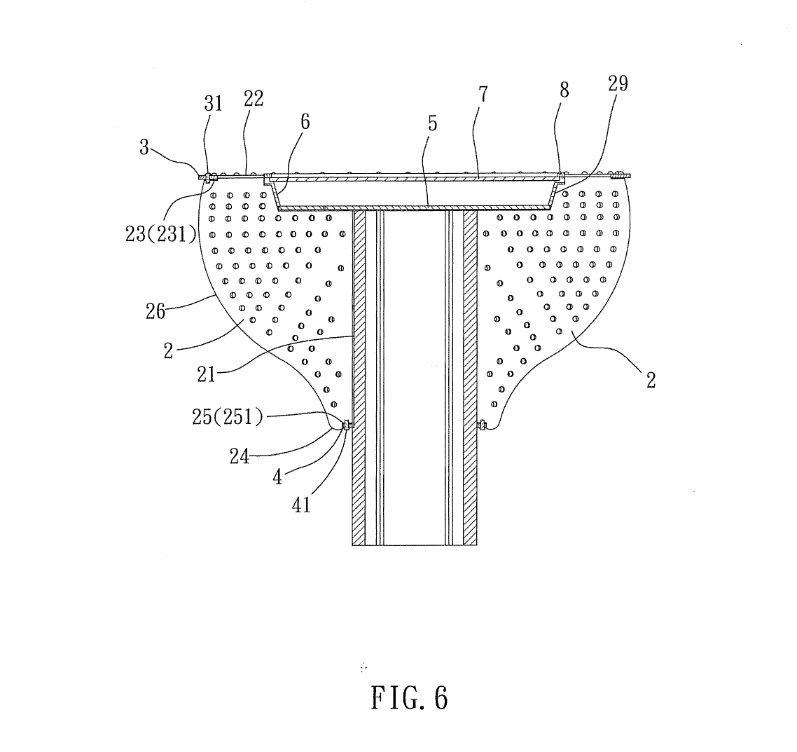

Referring to FIG. 6 and FIG. 4 again, in order to enhance mounting stability between the first locating frame 3 and second locating frame 4 and the radiation fins 2, a first step 27 is located at the top end 22 of each radiation fin 2 and abutted to the outer edge 26 for supporting the first locating frame 3. Further, the first lug 231 of the first mounting device 23 of each radiation fin 2 is located at the first step 27 for the mounting of the first locating frame 3. Similarly, as shown in FIGS. 5 and 6, a second step 28 is located at the bottom end 24 of each radiation fin 2 and abutted to the inner edge 21 for stopping against the second locating frame 4. Further the second lug 251 of the second mounting device 25 of each radiation fin 2 is located at the second step 28 for the mounting of the second locating frame 4.

Referring to FIGS. 4-6 again, each radiation fin 2 further comprises a relatively larger third step 29 located at the top end 22 and abutted against the inner edge 21, and a horizontal supporting flange 291 located at the third step 29. After insertion of the inner edges 21 of the radiation fins 2 into the respective longitudinal mounting grooves 11 of the heat-sink base 1, the third steps 29 of the radiation fins 2 define an accommodation chamber A to accommodate a heat transfer plate 5, an inner ring 6, a lens 7 and an outer ring 8. The heat transfer plate 5 is bonded to the horizontal supporting flanges 291 of the radiation fins 2 to support a LED light-emitting module (not shown). The inner ring 6 is mounted around the heat transfer plate 5. The lens 7 is mounted in the inner ring 6 over the LED light-emitting module (not shown) at the heat transfer plate 5. The outer ring 8 is fastened to the inner ring 6 to hold down the lens 7 in the inner ring 6.

In conclusion, the invention provides a heat dissipation module used for LED lamp, which involves an inventive step and is capable of industrial application. By means of inserting the radiation fins 2 into respective longitudinal mounting grooves 11 around the outer perimeter of the heat-sink base 1 and then riveting the first locating frame 3 and the second locating frame 4 to the top ends 22 and bottom ends 24 of the radiation fins 2, the heat dissipation module is assembled for outdoor applications. A LED lamp made using the heat dissipation module in accordance with the present invention is durable against weather, suitable for use a streetlight or searchlight application.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A heat dissipation module used in a LED lamp, comprising:
a heat-sink base comprising a plurality of longitudinal mounting grooves spaced around an outer perimeter thereof at predetermined intervals;
a plurality of radiation fins radially mounted around said heat-sink base, each said radiation fin comprising an inner edge fastened to one said longitudinal mounting groove of said heat-sink base, an outer edge opposite to said inner edge, a top end, a bottom end opposite to said top end, a first mounting device located at said top end, and a second mounting device located at said bottom end;
a first locating frame attached to the top ends of said radiation fins around said heat-sink base and fastened to the first mounting devices at the top ends of said radiation fins by respective first rivets; and
a second locating frame attached to the bottom ends of said radiation fins around said heat-sink base and fastened to the second mounting devices at the bottom end of said radiation fins by respective second rivets.

2. The heat dissipation module as claimed in claim 1, wherein said first mounting device of each said radiation fin comprises a first lug protruded from the top end of the respective radiation fin, and a rivet hole cut through said first lug and fastened to said first locating frame by one said first rivet; said second mounting device of each said radiation fin comprises a second lug protruded from the bottom end of the respective radiation fin, and a rivet hole cut through said second lug and fastened to said second locating frame by one said second rivet.

3. The heat dissipation module as claimed in claim wherein each said radiation fin further comprises a first step first step located at said top end and abutted to said outer edge to support said first locating frame; sad first lug of said first mounting device is located at said first step for the mounting of said first locating frame.

4. The heat dissipation module as claimed in claim 1, wherein each said radiation fin further comprises a second step located at said bottom end and abutted to said inner edge to support said second locating frame; said second lug of said second mounting device is located at said second step for the mounting of said second locating frame.

5. The heat dissipation module as claimed in claim 3, wherein said heat-sink base is shaped like a metal tube; said radiation fins are radially arranged around said heat-sink base in circle; said first locating frame and said second locating frame are ring shaped.

6. The heat dissipation module as claimed in claim 4, wherein said heat-sink base is shaped like a metal tube; said radiation fins are radially arranged around said heat-sink base in circle; said first locating frame and said second locating frame are ring shaped.

7. The heat dissipation module as claimed in claim 1, wherein each said radiation fin further comprises a third step located at said top end and abutted against said inner edge, and a horizontal supporting flange located at said third step, the horizontal supporting flanges of the third steps of said radiation fins being arranged on one same elevation and defining an accommodation chamber.

8. The heat dissipation module as claimed in claim further comprising a heat transfer plate bonded to the horizontal supporting flanges of said radiation fins to support a LED light-emitting module, an inner ring mounted around said heat transfer plate, a lens mounted in said inner ring over the LED light-emitting module at said heat transfer plate, and an outer ring fastened to said inner ring to hold down said lens in said inner ring.
